(19) United States
(12) Patent Application Publication
(10) Pub. No.: US 2005/0247845 A1
(43) Pub. Date: Nov. 10, 2005

(54) Support for computer peripheral device

(75) Inventors: Yi-Ru Li, Taipei (TW); Yong-Cen Chen, Taipei (TW)

Correspondence Address: BACON & THOMAS, PLLC, 625 SLATERS LANE, FOURTH FLOOR, ALEXANDRIA, VA, 22314, US

(73) Assignee: KYE SYSTEMS CORP., TAIPEI (TW)

(21) Appl. No.: 10/840,245

(22) Filed: May 7, 2004

(51) Int. Cl. A47G 1/17; G05G 1/14

(52) U.S. Cl. 248/346.5; 248/206.5; 248/678; 248/918

(57) ABSTRACT

A support for a computer peripheral device has a first coupling portion arranged to couple to a second coupling portion of the computer peripheral device. The first coupling portion has a first magnetic pole, and the second coupling portion has a second magnetic pole. Therefore, the first and second magnetic pole can be strongly attracted each other so as to hold the peripheral device at a desired angular position, while still permitting the device to be pivoted to any other desired angular position.

### BACKGROUND OF THE INVENTION

1. Field of the Invention

The present invention relates to a support, and in particular, to a support that allows a computer peripheral device to be pivoted or rotated to any desired angular position.

2. Description of the Prior Art

A computer peripheral device, such as a web camera, is usually coupled to a support in order to be located at a desired angular position. A complicated joint mechanism is commonly used in the support. For example, U.S. Pat. No. 6,431,507 discloses a camera 10 that is rotatable around a neck 10, the camera 10 being further movable up-and-down around an axis 19. U.S. Pat. No. 5,880,783 teaches a multi-axis revolving shaft structure 11 and 21 which enables rotation of the camera to various angular positions. In addition, U.S. Pat. No. D478922 shows a similar structure to facilitate the camera being fixed at any desired position.

The above-mentioned complex shaft structures have several defects, as listed below:
1. Some pivot structures are limited to a certain angle of rotation. In that case, a user may be forced to stay in a stationary pose.
2. Usually, the pivot structures are coupled with the camera together in a close-fit configuration (a tight-coupling). Whenever the pivot structure is moved or rotated, even if only occasionally, the configuration will gradually become loose.
3. In order to achieve a tight-coupling configuration, the pivot structure has to be carefully designed and manufactured. The more precise a fit that is needed, the higher the cost of tooling.

The lack of an adequate support structure has been a significant obstacle to the more widespread availability of inexpensive computer peripheral devices such as web cameras.

### SUMMARY OF THE INVENTION

It is accordingly an objective of the present invention to provide an efficient and easy-to-assemble support to couple with a computer peripheral device.

To achieve the objective mentioned above, the support has a first coupling portion arranged to couple to a second coupling portion on the computer peripheral device. The first coupling portion has a first magnetic pole structure, and the second coupling portion has a second magnetic pole structure. The first and second magnetic pole structures are strongly attracted each other so as to hold the peripheral device in a desired or selected angular position, while still permitting the device to be easily pivoted about the support and located at any other desired or selected angular position.

### BRIEF DESCRIPTION OF THE DRAWINGS

FIG. 1 is a exploded view of the present invention connected.

FIG. 2 is a lateral view of the present invention.

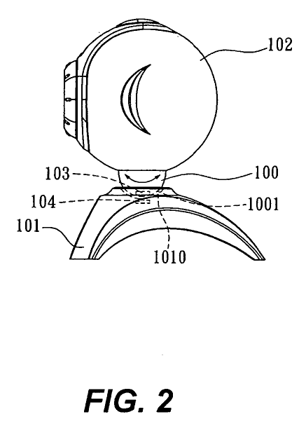

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

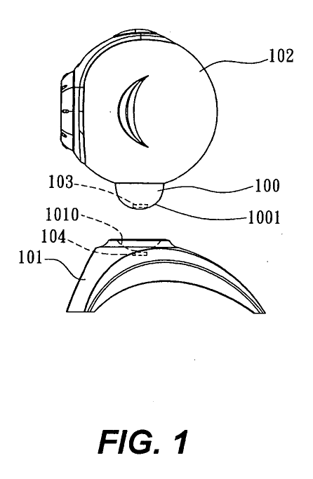

The term computer peripheral device as used herein is intended to encompass any computer-related device, such as a digital camera, web camera, tablet stylus, wireless receiver, wireless network card, and so forth. Referring to FIG. 1, the support 101 has a first coupling portion 1010 and a first magnetic pole structure 104. The device, such as a web camera 102 also has a second coupling portion 100, and the second coupling portion 100 further has a second magnetic pole structure 1001. The first and the second magnetic pole structures 101, 100 may be permanent magnets. Therefore, the first and second magnetic pole structures 101, 100 can be strongly attracted each other so as to hold the peripheral device at a desired angular position, and yet pivoted about the support 101 to be located at any desired angle.

Those skilled in the art will appreciate that the coupling portions can have any of a wide variety of well-known configurations. For example, the first coupling portion may be a recess and the second coupling portion 100 a protrusion. Alternatively, the recess may easily be located on the device 102 and the protrusion located in the support 101.

In order to lower the cost, either the first magnetic pole structure 104 or the second magnetic pole structure 103 can be made of a magnetizable material, such as an iron-like metal. Thus, the first and second magnetic pole structures 101, 100 can be strongly attracted to each other and also coupled together.

In mass production, the magnitude of the magnets' attraction and the location of the magnets have to be carefully calculated to avoid excessive attraction or insufficient attraction therebetween. Also, the position of the center of gravity of the device must be selected so that the device 102 can be appropriately located at any desired position.

While the description above refers to particular embodiments of the present invention, it will be understood that many modifications may be made without departing from the spirit thereof. The accompanying claims are intended to cover such modifications as would fall within the true scope and spirit of the present invention.

1. A support structure for a computer peripheral device, comprising:
a support;
a first coupling portion on the support, the first coupling portion including a first magnetic pole structure;
a second coupling portion on the device, the second coupling portion including a second magnetic pole structure;
whereby the first and second magnetic pole structures are magnetically attracted to each other and coupled together such that the device can be held by the magnetic attraction in a selected angular position, and pivoted about the support to located at another selected angular position.

2. The support as claimed in claim 1, wherein at least one of the first and the second magnetic pole structures is a permanent magnet.

3. The support as claimed in claim 1, wherein at least one of the first and the second magnetic pole structures is an electromagnet.

4. The support as claimed in claim 1, wherein one of the first and the second magnetic pole structures is made of a magnetizable material.

5. The support as claimed in claim 1, wherein the first coupling portion is a recess, and the second coupling portion is a protrusion which is shaped correspondingly to the recess.
